(19) United States
(12) Patent Application Publication
(10) Pub. No.: US 2015/0170814 A1
(43) Pub. Date: Jun. 18, 2015

(54) FERRITE CONFIGURATION FOR GUIDING A MAGNETIC FLUX, METHOD OF PRODUCING THE FERRITE CONFIGURATION, COIL CONFIGURATION, ELECTRICALLY DRIVABLE VEHICLE AND CHARGING STATION

(71) Applicant: SIEMENS AKTIENGESELLSCHAFT, MUENCHEN (DE)

(72) Inventors: MANUEL BLUM, OTTOBRUNN (DE); THOMAS KOMMA, OTTOBRUNN (DE); MONIKA POEBL, MUENCHEN (DE)

(21) Appl. No.: 14/569,998

(22) Filed: Dec. 15, 2014

(30) Foreign Application Priority Data
Dec. 13, 2013 (DE) 102013225875.5

(51) Int. Cl. H01F 3/00; B60L 11/18; H01F 41/00; H01F 27/28

(52) U.S. Cl. CPC H01F 3/00; H01F 27/28; B60L 11/182; H01F 41/00

(57) ABSTRACT

A ferrite configuration for guiding a magnetic flux has at least two prismatically configured ferrite segments which form a cross-sectional area, perpendicular to a direction of the magnetic flux to be guided, for the magnetic flux to be guided and which are arranged adjacent to one another in such a manner that two surfaces of the adjacently arranged ferrite segments face one another perpendicular to the direction of the magnetic flux to be guided and form an air gap such that an air gap length is formed within the ferrite configuration in the direction of the magnetic flux. The ferrite segments are arranged in such a manner that the air gap lengths at any location of the cross-sectional area is of equal length across the cross-sectional area of the ferrite configuration.

### CROSS-REFERENCE TO RELATED APPLICATION

This application claims the priority, under 35 U.S.C. §119, of German application DE 10 2013 225 875.5, filed Dec. 13, 2013; the prior application is herewith incorporated by reference in its entirety.

### BACKGROUND OF THE INVENTION

### Field of the Invention

The present invention relates to a ferrite configuration for guiding a magnetic flux, having at least two prismatically configured ferrite segments which form a cross-sectional area, perpendicular to a direction of the magnetic flux to be guided, for the magnetic flux to be guided and which are arranged adjacent to one another in such a manner that two surfaces of the adjacently arranged ferrite segments are situated facing one another perpendicular to the direction of the magnetic flux to be guided and form an air gap such that an air gap length is formed within the ferrite configuration in the direction of the magnetic flux. In addition, the invention relates to a method for manufacturing a ferrite configuration for guiding a magnetic flux, wherein at least two prismatically configued ferrite segments which form a cross-sectional area, perpendicular to a direction of the magnetic flux to be guided, for the magnetic flux to be guided are arranged adjacent to one another in such a manner that two surfaces of the adjacently arranged ferrite segments are situated facing one another perpendicular to the direction of the magnetic flux to be guided and form an air gap having an air gap length in the direction of the magnetic flux within the ferrite configuration. The invention furthermore relates to a coil configuration having an electrical coil which has a winding consisting of an electrical conductor. In addition, the invention relates to an electrically drivable vehicle having a drive device which contains an electrical machine, an electrical energy store for supplying the electrical machine with electrical energy when the vehicle is in a period of driving operation, and a charging device for delivering electrical energy to the energy store, wherein the charging device contains a coil configuration for the wireless energy-related coupling of an energy source. Finally, the invention also relates to a charging station for an electrically drivable vehicle, having a connection for an electrical energy source, a converter and a coil configuration connected to the converter for the wireless energy-related coupling of a charging device of the electrically drivable vehicle in order to deliver energy to the vehicle.

Ferrites are electrically poorly conducting or non-conducting ferromagnetic ceramic materials, composed for example of an iron oxide such as hematite, magnetite, further metal oxides, combinations thereof or the like. Depending on the composition, ferrites can be hard magnetic or soft magnetic. Ferrites are employed in the case of energy converters or energy couplers when an alternating magnetic field is used. They are frequently used as a back iron in the case of coil configurations. On account of their low electrical conductivity they are suitable in particular for use in the case of alternating magnetic fields having a high frequency.

Ferrite configurations are furthermore employed in the case of charging devices, in particular the coil configurations thereof, which are configured in order to establish a wireless energy-related coupling with a charging device, in particular of the electrically drivable vehicle, from which they receive energy transferred by the alternating magnetic field.

Charging devices for the wireless energy-related coupling of an energy source are known in principle so there is no need for separate documentary proof therefor. A unit of electrical equipment, for example an electrically drivable vehicle, has a charging device in order to enable energy to be delivered to the equipment, in particular the vehicle, which energy is made available and/or stored in an energy store of the equipment or of the vehicle for the purpose of carrying out normal operation. The energy is made available as a rule by means of a charging station which for its part is connected to an electrical energy source, for example to a public energy supply network, to an electrical generator and/or the like, from which it accordingly obtains electrical energy.

One possible means of delivering the energy from the charging station to the charging device of the electrically drivable vehicle consists in establishing an electrical connection by a cable between the vehicle and the charging station. Furthermore, according to a further option it is known to establish a wireless energy-related coupling which avoids a complex mechanical connection using cables. To this end a coil configuration is provided as a rule in each case on the charging station side and the vehicle side, which coil configurations are arranged facing one another for the purpose of energy transfer and which enable an energy-related coupling by utilizing the alternating magnetic field.

Charging stations of the generic kind serve to provide an electrically drivable vehicle with energy during a period of charging operation in order that the electrically drivable vehicle is able to perform its normal function, in particular during the period of driving operation. The electrically drivable vehicle requires the energy for the driving operation.

Vehicles of the generic kind having a charging device for the wireless transfer of energy by an alternating magnetic field are likewise known in principle so there is also no need for separate documentary proof therefor. The electrically drivable vehicle has the charging device in order to enable energy to be delivered to the electrically drivable vehicle, which energy is preferably stored in an energy store of the vehicle for the purpose of carrying out normal operation, namely the period of driving operation. The energy is made available as a rule by the charging station, which for its part is connected to the electrical energy source. The charging station generates the alternating magnetic field while receiving electrical energy from the electrical energy source. The charging device of the vehicle captures the alternating magnetic field, extracts energy therefrom and makes the electrical energy available on the vehicle side, in particular in order to supply the electrical energy store of the vehicle and/or the electrical machine of the drive device with electrical energy.

A coil configuration is provided in each case both on the vehicle side and also on the charging station side, which coil configurations, are coupled with one another wirelessly in energy-related fashion by way of the alternating magnetic field. In order to be able to achieve as high a level of effectiveness as possible of the energy-related coupling by the coil configurations, a back iron in the form of a ferrite configuration is provided as a rule both on the vehicle side and also on the charging station side. By this means the magnetic flux can be guided in the desired manner and a high level of effectiveness of the energy-related coupling can be achieved.

With regard to the coil configurations used in particular in the area of electrically drivable vehicles, for example in the embodiment as a solenoid, the dimensions of the coil assembly are determined inter alia by the ferrite configuration. In an effort to keep the dimensions of the coil configuration as small as possible it has been shown that a reduction in the cross-sectional area of the ferrite configuration can result in local overheating. This impairs the function and the reliability of the coil configuration as well as of the further facilities connected thereto.

### SUMMARY OF THE INVENTION

The object of the invention is therefore to specify a ferrite configuration, a method for the manufacture thereof, a coil configuration, a charging station and also an electrically drivable vehicle which have improved characteristics.

To achieve this object the invention proposes a ferrite configuration and also a method for manufacturing a ferrite configuration for guiding a magnetic flux. The invention further relates to a coil configuration side having a coil configuration, an electrically drivable vehicle, and a charging station.

The invention is based on the knowledge that, in particular, if the coil configuration provides a wireless energy-related coupling, also referred to as an inductive transfer system, particularly if the coil configuration is configured as a solenoid, increased magnetic flux densities can occur in the ferrite configuration in comparison with other embodiments of coils. On account of the technical requirements and/or feasibility, such ferrite configurations are frequently segmented, in particular in the case of a solenoid, and consist not only of a single ferrite part but then of a plurality of ferrite parts or ferrite segments.

With ceramic components, which are frequently very brittle, there exists a danger of breakage in the case of large dimensions, in particular also in the event that for example during a period of driving operation of an electrically drivable vehicle vibrations and shocks are able to affect the ferrite configuration. For this reason the ferrite configuration is as a rule formed in segmented fashion from a predetermined number of ferrite segments which are arranged appropriately with respect to one another in order to achieve a desired predetermined flux concentration of the magnetic flux.

It has been shown that the transition of the magnetic flux from one ferrite segment to another is influenced by the generally unavoidable air gap, as a result of which the flux guidance in the ferrite configuration itself is also influenced. Due to the air gap, a distribution of the magnetic flux density over the cross-sectional area of the magnetic flux to be guided can become very inhomogeneous. This can be caused or also compounded inter alia by varying air gap lengths in the direction of the magnetic flux to be guided over the cross-sectional area. If the transitions or air gaps between adjacent ferrite segments are formed inhomogeneously in the direction of the magnetic flux, this results in an uneven flux distribution of the magnetic flux over the cross-section of the ferrite configuration. Inhomogeneities thereby result in respect of the loading of individual ferrite segments and also in consequence thereof the local increases in temperature within the ferrite configuration.

Given a sufficiently large cross-sectional area of the ferrite configuration, the cross-sectional area is adequate in order to compensate for possibly occurring in homogeneities. This means that the dimensions of the ferrite segments are chosen to be sufficiently large in their own cross-sectional area in order to guide the magnetic flux. For this reason, in particular the thickness of the ferrite segments should be chosen to be sufficiently great. This is however at odds with compactness, in particular a reduction in the thickness of the ferrite segments.

In order to be able to reduce the dimensions of the ferrite configuration, provision is made in particular to reduce the cross-sectional area of the ferrite configuration perpendicular to the direction of the magnetic flux. As a result however the problems mentioned in the introduction with regard to the ferrite configuration can occur.

The invention provides a possible means of avoiding or of reducing the aforementioned problems. In particular, the invention makes it possible to reduce the cross-sectional area for the magnetic flux to be guided. In this situation the invention is based on the knowledge that a magnetic resistance for the magnetic flux within a ferrite segment is very small compared with a magnetic resistance of an air gap.

Since the ferrite configuration is composed of a plurality of smaller ferrite segments, the magnetic resistance is increased at the transition points of adjacent ferrite segments in the direction of the magnetic flux on account of the air gap. With regard to the prior art, inhomogeneities of the magnetic flux density across the cross-sectional area are tolerated at this point. In the case of a reduction in cross-sectional area, in particular a reduction in thickness of the ferrite segments, this can result in local overheating of the ferrite segments. This limits the reduction in the cross-section of the ferrite configuration for guiding the magnetic flux with regard to the prior art.

The invention opens up a possibility to reduce the unfavorable distribution of the magnetic flux density across the cross-sectional area of the ferrite configuration, as a result of which the aforementioned problems, in particular in respect of the heating, can be significantly reduced. It is thereby possible to better utilize the ferrite configuration overall, by which free spaces can be achieved in order to reduce the cross-sectional area, for example the thickness of the ferrite segments and in consequence thereof the constructional height of a coil configuration.

The invention achieves this in that not only ferrite segments are arranged in random fashion but also in that the ferrite segments, which in the present case are prismatic ferrite segments, are arranged in such a manner that the air gap lengths at any locations of a particular air gap of the cross-sectional area are essentially of equal length across the cross-sectional area of the ferrite configuration. It is thereby possible to largely reduce in homogeneities caused by air gaps such that an essentially homogeneous magnetic resistance can be provided for the magnetic flux across the cross-sectional area. In consequence thereof an essentially homogeneous flux density distribution of the magnetic flux density is established across the cross-sectional area of the ferrite configuration. The invention therefore utilizes the knowledge that the geometry of the air gap or air gaps has a considerable influence on the distribution of the magnetic flux or a gradient of the magnetic flux density over the cross-sectional area. The cross-sectional area is preferably an area provided along its extent by the ferrite configuration for the magnetic flux to be guided, which area is formed perpendicular to the direction of the magnetic flux to be guided.

The ferrite segments are configured in particular as geometric bodies in the form of a prism and preferably all exhibit the same geometric form. A prism is a geometric body which has a polygon as its base and the lateral edges of which are essentially parallel and of equal length. A prism can be created by parallel displacement of a quadrilateral forming a flat base along a straight line not lying in this plane in the space. A prism is consequently a special polyhedron. A preferred embodiment for ferrite segments is a prism having a rectangular base, in particular the cuboid form.

It is particularly advantageous if the ferrite segments have a relative magnetic permeability greater than 1, preferably greater than 10, in particular greater than 100. The ferrite segments can be arranged in a horizontal plane for the ferrite configuration. The ferrite segments are manufactured for example as sintered bodies and have high proportions of iron oxide, magnetite, other magnetizable oxides and/or the like.

The plane in that the ferrite segments are arranged and also the ferrite segments themselves are preferably not curved.

A particularly practical embodiment of the invention provides that, in particular, surfaces of the ferrite segments which face the air gap are essentially flat, in other words exhibit no curvature. This makes it possible for the opposite surfaces of adjacent ferrite segments forming an air gap to be aligned essentially parallel to one another. This ensures in a particularly simple manner that essentially the same air gap length is present at any points of the air gap. The respective local magnetic resistance of the air gap is thus locally constant for the magnetic flux essentially across the cross-sectional area, which means that a flux concentration of the magnetic flux on account of varying magnetic resistances of the air gap can be largely avoided.

In addition, provision can naturally be made that the surfaces of adjacent ferrite segments facing the air gap have corresponding contours on the surface, which means that it is possible in this manner to ensure that the same air gap length can be achieved at any points across the cross-section of the air gap. The air gap length orientates itself in this situation on the respective local direction of the magnetic flux.

A development of the invention provides that the air gap has a spacer defining the air gap length. Accordingly, the ferrite segments are positioned and/or aligned by means of a spacer. The spacer, which is preferably formed from a non-ferromagnetic or non ferrimagnetic material, thus serves as a gage for positioning the adjacent ferrite segments, such that an air gap having the desired properties can be achieved.

Alternatively, provision can naturally also be made that the surfaces of adjacent ferrites abut directly against one another and an air gap is created only by surface roughness of the surfaces of adjacent ferrite segments abutting against one another. Accordingly, surfaces of ferrite segments arranged adjacent to one another abut directly against one another perpendicular to a direction of the magnetic flux to be guided. A very low magnetic resistance of the air gap can thereby be achieved. Deviations of the air gap length across the cross-section of the magnetic flux to be guided can thus be reduced or kept to a minimum.

According to a development it is proposed that the ferrite configuration has a plurality of ferrite segments, wherein in each case at least two ferrite segments are arranged adjacent to one another perpendicular to the direction of the magnetic flux, wherein totals of the respective air gap lengths in the direction of the magnetic flux to be guided across the cross-sectional area are the same in each case. This embodiment is suitable in particular for the case that on account of the cross-section requirement for the magnetic flux to be guided and external constraints for the available space the configuration of the ferrite segments requires that a different number of air gaps is the consequence at different points of the cross-section of the magnetic flux to be guided. As a result of the fact that over the entire path of the magnetic flux to be guided the air gap lengths over the cross-section are generally constant in each case, a homogenization of the magnetic flux density across the cross-section of the magnetic flux to be guided can essentially also be achieved in this case.

It proves to be particularly advantageous in the case of the aforementioned embodiment if regions having a different number of air gaps are spaced apart from one another over the total extent of the ferrite configuration, in other words, if the ferrite segments are spaced apart perpendicular to the direction of the magnetic flux with a distance greater than the air gap between two adjacent ferrites in the direction of the magnetic flux. This makes it possible for the magnetic flux not to be displaced into the region with the lower number of air gaps and thus over the direction of extent of the ferrite configuration for flux density concentrations to be produced beside the air gaps locally on account of adjacent air gaps.

The invention furthermore proposes that at least one surface of the ferrite segments facing the air gap exhibits a roughness of less than 1 μm, in particular less than 200 nm. This makes it possible for the air gap lengths, in particular in the case of parallel surfaces situated opposite one another of adjacent ferrite segments, which form an air gap, to be essentially of the same length. This embodiment proves to be particularly advantageous if the surfaces situated opposite one another of the adjacent ferrite segments abut directly against one another. As a result of the slight roughness, variations in the air gap lengths across the cross-section of the magnetic flux to be guided can be reduced, whereby effects on the magnetic flux to be guided can likewise be reduced. The roughness can be ascertained and/or specified in accordance with DIN 4760 or the like.

With regard to the method, it is further proposed that at least one surface of the ferrite segments which is associated with the air gap is ground. In particular, each surface of the ferrite segments which is associated with an air gap should be ground. A slight roughness of the surface and/or a curvature of the surface which is essentially to be disregarded can thereby be achieved. Both measures, both individually and also jointly, make it possible to improve a distribution of the magnetic flux density across the cross-section of the magnetic flux to be guided.

The invention further proposes a coil configuration having an electrical coil which has a winding consisting of an electrical conductor, wherein the coil configuration contains a ferrite configuration according to the invention. The advantage of the inventive ferrite configuration can thereby be achieved with the coil configuration. The coil serves to provide interaction with an alternating magnetic field in the context of the operation of a wireless energy-related coupling. Depending on the interaction of the coil with the alternating magnetic field, an electrical voltage can be made available at terminals of the coil by the electrical conductor.

Finally, the invention proposes an electrically drivable vehicle which is characterized by the fact that the coil configuration thereof has a ferrite configuration according to the invention. This makes it possible for dimensions of the coil configuration to be reduced, by which space and weight can be saved in the vehicle. Furthermore, the aforementioned advantages of the ferrite configuration can also be realized by the invention. By the coil configuration it is possible to deliver energy to the electrically drivable vehicle, namely by way of a wireless energy-related coupling with an alternating magnetic field which interacts with the coil configuration. The alternating magnetic field can be made available by a suitably equipped charging station.

Finally, the invention also proposes a charging station for an electrically drivable vehicle, wherein the coil configuration of the charging station has a ferrite configuration according to the invention. The charging station is thereby able to generate higher power densities or flux densities with existing dimensions, which means that the level of effectiveness or the performance of the wireless energy-related coupling can be improved.

Further advantages and features will be described in the following on the basis of exemplary embodiments with reference to the figures. The same components and functions are identified by the same reference characters in the figures. The exemplary embodiments serve only to explain the invention and are not intended to restrict the invention.

Other features which are considered as characteristic for the invention are set forth in the appended claims.

Although the invention is illustrated and described herein as embodied in a ferrite configuration for guiding a magnetic flux, a method of producing the ferrite configuration, a coil configuration, an electrically drivable vehicle and a charging station it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a ferrite configuration having ferrite segments, wherein a different number of air gaps is present in a direction of extent of the ferrite configuration in a direction of magnetic flux across a cross-section of the magnetic flux to be guided; and

FIG. 2 is an illustration of a ferrite configuration having ferrite segments according to the invention.

### DETAILED DESCRIPTION OF THE INVENTION

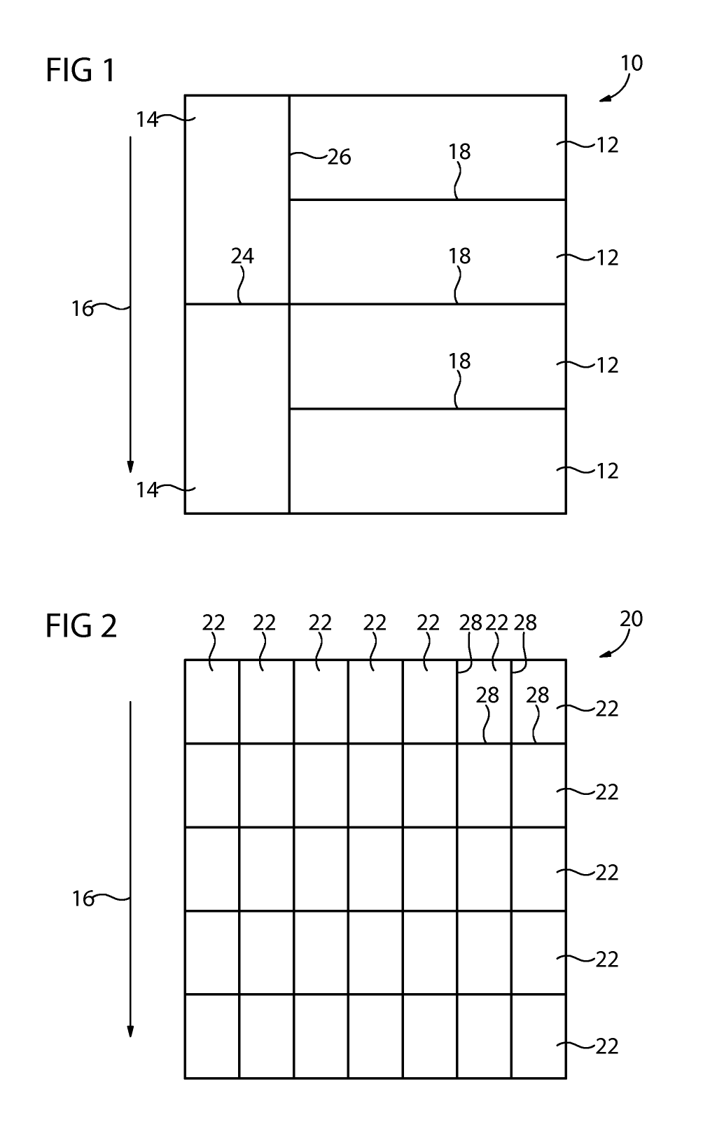

Referring now to the figures of the drawings in detail and first, particularly to FIG. 1 thereof, there is shown a ferrite configuration 10 having ferrite segments 12, 14, wherein the ferrite segments 12, 14 are configured as cuboid-shaped prisms which have a thickness of approximately 4 mm. The ferrite segments 12 have edge lengths of 4 cm and 6 cm, whereas the ferrite segments 14 have edge lengths of 4 cm and 8 cm.

In the ferrite configuration 10 according to FIG. 1 the ferrite segments 12 are arranged in a flat plane with their 6 cm-long long sides directly adjacent to one another. In the ferrite configuration 10 shown in FIG. 1 the four ferrite segments 12 are arranged in such a manner that they abut against one another with their long sides and in this manner form three air gaps 18 which are oriented perpendicular to the direction of flow 16 of the magnetic flux to be guided. Arranged adjacent hereto are two ferrite segments 14, the short 4 cm-long sides of which abut against one another in the direction of flow 16 and form an air gap 24. Furthermore, the configuration formed hereby abuts directly against the adjacent configuration of the ferrite segments 12 such that the air gap 24 and the central one of the air gaps 18 form a common air gap.

In practical operation, on account of the air gaps 18, 24 a flux density distribution is established which results in an increased magnetic flux density in the ferrite segments 14. In consequence thereof, an increased power loss occurs in the ferrite segments 14 on account of the effect of the magnetic flux. Accordingly, local heating or overheating in the region of the ferrite segments 14 is the consequence. This is due to the fact that the magnetic resistance in the direction of the magnetic flux 16 in the region of the ferrite segments 14 is only ⅓ of the magnetic resistance in the ferrite segments 12 on account of the single air gap 24. The magnetic resistance is determined predominantly by the magnetic resistances in the present case, whereas the magnetic resistance in the region of the ferrite segments 12 is formed essentially by the three air gaps 18 which from the viewpoint of the magnetic flux are arranged in series. With regard to the magnetic flux, a parallel circuit is thereby produced, consisting of the ferrite segments 14 on the one hand and the ferrite segments 12 on the other hand. According to the respective magnetic resistance, the magnetic flux is thus distributed on account of the lower magnetic resistance predominantly onto the region of the ferrite segments 14, which causes a correspondingly high power loss in the ferrite segments 14. The ferrite segments 12 are however loaded comparatively lightly by the magnetic flux, which means that in comparison with the ferrite segments 14 the power loss in the ferrite segments 12 is considerably lower. The ferrite segments 12 are not operated at optimum capacity in respect of their capabilities hereby, whereas the ferrite segments 14 are overloaded.

FIG. 2 now shows an embodiment of a ferrite configuration 20 according to the invention that is formed from prismatic ferrite segments 22 which all exhibit a thickness of 3 mm and exhibit edge lengths of 3 cm and 2 cm. The ferrite segments 22 are thus configured in cuboid form and arranged in a flat plane in a checkerboard fashion. Between adjacent surfaces of the ferrite segments 22 air gaps 28 are thereby formed which are generally homogeneous and equal. A constant number of air gaps 28 in each case are thereby produced for the magnetic flux across the cross-sectional area of the ferrite configuration 20 formed by the ferrite segments 22 over the extent of the ferrite configuration 20 in the direction of flow 16, such that a similarly homogeneous distribution develops for the magnetic resistance. This ensures that the magnetic flux in the direction of flow 16 is distributed generally evenly over the ferrite segments 28 and thus magnetic flux acts evenly upon the ferrite segments 22. This configuration is not dependent on air gaps perpendicular to the direction of flow 16 between adjacent ferrite segments 22.

The invention serves to ensure that the magnetic flux is distributed evenly over the ferrite segments 22, which also means that a power loss is distributed evenly generally over all the ferrite segments 22. This makes it possible for the thickness of the ferrite segments 22 to be reduced such that overall a constructional height of a coil configuration having such a ferrite configuration 20 can be reduced.

A further embodiment of the invention on the basis of FIG. 1 makes provision that a sum of air gap lengths of the air gaps 18 is equal to an air gap length of the air gap 24. The ferrite segments 12, 14 are arranged accordingly to this end. In addition, a further air gap 26 is provided perpendicular to the direction of flow 16, the air gap length of which perpendicular to the direction of flow 16 exceeds the air gap length of the air gap 24 in the direction of the air gap 16 by approximately a factor of 10. This ensures that magnetic flux, which is guided through the ferrite segments 12, cannot be displaced locally into the respective ferrite segment 14 in the region of the first and the last air gap 18 and can thus lead to a local in homogeneity in the flux density loading.

In the exemplary embodiment according to FIG. 2 provision is made that the surfaces of the ferrite segments 22 arranged adjacent to one another are ground and exhibit a surface roughness of less than 200 nm.

Overall it proves to be advantageous that gradients of the magnetic flux density in a cross-sectional area of the magnetic flux to be guided can be generally homogenized by the invention such that local overheating on account of flux density concentrations of the magnetic flux can be reduced, if not entirely avoided.

The exemplary embodiments described with reference to the figures serve only to explain the invention and are not intended to restrict the invention.

The person skilled in the art will naturally provide appropriate variations as required without departing from the core concept of the invention. In particular, individual features can be combined with one another in any desired fashion according to requirements. Furthermore, device features can naturally be implemented by corresponding method steps and vice versa.

1. A ferrite configuration for guiding a magnetic flux, comprising:
at least two prismatically configured ferrite segments forming a cross-sectional area for the magnetic flux to be guided, perpendicular to a direction of the magnetic flux to be guided, said ferrite segments disposed adjacent to one another such that two surfaces of adjacently disposed ferrite segments situated facing one another perpendicular to the direction of the magnetic flux to be guided and form an air gap there-between such that an air gap length is formed within the ferrite configuration in the direction of the magnetic flux, said ferrite segments disposed such that air gap lengths at any locations of said cross-sectional area are of equal length across said cross-sectional area of the ferrite configuration.

2. The ferrite configuration according to claim 1, further comprising spacers for defining an air gap length.

3. The ferrite configuration according to claim 1, wherein said surfaces of said ferrite segments disposed adjacent to one another abut directly against one another perpendicular to the direction of the magnetic flux to be guided.

4. The ferrite configuration according to claim 1, wherein said at least two prismatically configured ferrite segments are two of a plurality of ferrite segments, wherein in each case at least two of said ferrite segments are disposed adjacent to one another perpendicular to the direction of the magnetic flux, wherein totals of said air gap lengths in the direction of the magnetic flux to be guided across the cross-sectional area are the same in each case.

5. The ferrite configuration according to claim 4, wherein said ferrite segments are spaced apart perpendicular to the direction of the magnetic flux with a distance greater than said air gap.

6. The ferrite configuration according to claim 1, wherein at least one surface of said ferrite segments facing said air gap exhibits a roughness of less than 1 μm.

7. The ferrite configuration according to claim 1, wherein at least one surface of said ferrite segments facing said air gap exhibits a roughness of less than 200 nm.

8. A method for manufacturing a ferrite configuration for guiding a magnetic flux, which comprises the steps of:
disposing at least two prismatically configured ferrite segments forming a cross-sectional area for the magnetic flux to be guided, perpendicular to a direction of the magnetic flux to be guided, the ferrite segments disposed adjacent to one another such that two surfaces of adjacently disposed ferrite segments are situated facing one another perpendicular to the direction of the magnetic flux to be guided and form an air gap there-between having an air gap length in the direction of the magnetic flux within the ferrite configuration, the ferrite segments disposed such that air gap lengths at any locations of the cross-sectional area are of equal length across the cross-sectional area of the ferrite configuration.

9. The method according to claim 8, which further comprising positioning and/or aligning the ferrite segments by means of a spacer.

10. The method according to claim 8, which further comprises grinding at least one surface of the ferrite segments associated with the air gap.

11. A coil configuration, comprising:
an electrical coil containing a winding having an electrical conductor and the ferrite configuration according to claim 1.

12. An electrically drivable vehicle, comprising:
a drive device having an electrical machine;
an electrical energy store for supplying said electrical machine with electrical energy in a period of driving operation of the vehicle; and
a charging device for delivering the electrical energy to said electrical energy store, wherein said charging device containing a coil configuration for a wireless energy-related coupling of said electrical energy source, said coil configuration having a ferrite configuration according to claim 1.

13. A charging station for an electrically drivable vehicle, the charging station comprising:
a connection for an electrical energy source;
a converter; and
a coil configuration connected to said converter for a wireless energy-related coupling of a charging device of the electrically drivable vehicle in order to deliver energy to the vehicle, said coil configuration having a ferrite configuration according to claim 1.
